(19) United States
(12) Patent Application Publication
(10) Pub. No.: US 2022/0113692 A1
(43) Pub. Date: Apr. 14, 2022

(54) PROGRAMMABLE SURFACE OBJECT

(71) Applicant: Michael McDougall, Waltham, MA (US)

(72) Inventor: Michael McDougall, Waltham, MA (US)

(21) Appl. No.: 17/501,355

(22) Filed: Oct. 14, 2021

Related U.S. Application Data
(60) Provisional application No. 63/091,733, filed on Oct. 14, 2020.
(60) Provisional application No. 63/106,598, filed on Oct. 28, 2020.
(60) Provisional application No. 63/180,836, filed on Apr. 28, 2021.

(51) Int. Cl. G05B 19/042; E04F 15/22

(52) U.S. Cl. CPC G05B 19/042; G05B 2219/23444; E04F 15/225

(57) ABSTRACT

Disclosed herein is a programmable surface object, in accordance with some embodiments. Accordingly, the programmable surface object may include a structure and a plurality of variable compressibility elements. Further, the plurality of variable compressibility elements may be configured for allowing compressing of the structure to one of a plurality of compression levels corresponding to one of a plurality of energy stimuli received by the plurality of variable compressibility elements, wherein the compressing of the structure allows deforming of the programmable surface object to one of a plurality of deforming degrees.

The current application claims a priority to the U.S. Provisional Patent application Ser. No. 63/091,733 filed on Oct. 14, 2020. The current application also claims a priority to the U.S. Provisional Patent application Ser. No. 63/106,598 filed on Oct. 28, 2020. The current application claims a priority to the U.S. Provisional Patent application Ser. No. 63/180,836 filed on Apr. 28, 2021.

### FIELD OF THE INVENTION

Generally, the present disclosure relates to the field of amusement devices. More specifically, the present disclosure relates to a programmable surface object.

### BACKGROUND OF THE INVENTION

Existing objects are deficient with regard to several aspects. For instance, current objects do not include a surface that is programmable. Furthermore, current objects do not include a hard surface that is capable of transforming into a soft surface that is capable of absorbing impacts from other objects.

Therefore, there is a need for a programmable surface object that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a programmable surface object, in accordance with some embodiments. Accordingly, the programmable surface object may include a structure and a plurality of variable compressibility elements. Further, the plurality of variable compressibility elements may be configured for allowing compressing of the structure to one of a plurality of compression levels corresponding to one of a plurality of energy stimuli received by the plurality of variable compressibility elements. Further, the compressing of the structure allows deforming of the programmable surface object to one of a plurality of deforming degrees.

Further disclosed herein is a programmable surface object, in accordance with some embodiments. Accordingly, the programmable surface object may include a structure and a plurality of variable compressibility elements. Further, the plurality of variable compressibility elements may be configured for allowing compressing of the structure to one of a plurality of compression levels corresponding to one of a plurality of energy stimuli received by the plurality of variable compressibility elements. Further, the compressing of the structure allows deforming of the programmable surface object to one of a plurality of deforming degrees. Further, the structure may include a panel. Further, the plurality of variable compressibility elements may include at least one rigid support and at least one spring. Further, a base end of the at least rigid support and the at least one spring may be disposable on at least one surface and a top end of the at least one rigid support and the at least one spring may be interfacable with the panel. Further, the at least one rigid support may be configurable for transitioning between an extended state and at least one retracted state. Further, the at least one rigid support may be configured for supporting the panel in the extended state preventing the compressing of the structure. Further, the at least one rigid support does not support the panel in the at least one retracted state allowing the compressing of the structure. Further, the at least one spring may be configurable for transitioning between an extended spring state and at least one compressed spring state. Further, a support length of the at least one rigid support in the extended state may be greater than a spring length of the at least one spring in the extended spring state and the support length of the at least one rigid support in the at least one retracted state may be smaller than the spring length of the at least one spring in the at least one retracted state. Further, the at least one rigid support prevents interfacing of the at least one spring with the at least one programmable surface for preventing receiving of one of the plurality of energy stimuli by the at least one spring through the panel in the extended state. Further, the preventing of the receiving of one of the plurality of energy stimuli prevents the transitioning of the at least one spring to the at least one compressed spring state from the extended spring state. Further, preventing the transitioning prevents the compressing of the structure. Further, the at least one rigid support allows interfacing of the at least one spring with the panel for allowing the receiving of one of the plurality of energy stimuli by the at least one spring through the panel in the at least one retracted state. Further, the allowing of the receiving of one of the plurality of energy stimuli allows the transitioning of the at least one spring to the at least one compressed spring state from the extended spring state. Further, allowing the transitioning allows the compressing of the structure.

Further disclosed herein is a programmable surface object, in accordance with some embodiments. Accordingly, the programmable surface object may include a structure and a plurality of variable compressibility elements. Further, the plurality of variable compressibility elements may be configured for allowing compressing of the structure to one of a plurality of compression levels corresponding to one of a plurality of energy stimuli received by the plurality of variable compressibility elements. Further, the compressing of the structure allows deforming of the programmable surface object to one of a plurality of deforming degrees. Further, the structure may include at least one cavity. Further, the plurality of variable compressibility elements may include at least one material and at least one inserting device. Further, the at least one inserting device may be coupled with the at least one cavity. Further, the at least one inserting device may be configured for removably inserting the at least one material in the at least one cavity in one of a plurality of amounts based on one of a plurality of electrical energy stimuli of the plurality of energy stimuli received by the at least one inserting device. Further, the allowing of the compressing of the structure to one of the plurality of compression levels may be based on the removably inserting of the at least one material in the at least one cavity in one of the plurality of amounts.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front perspective view of a programmable surface object, in accordance with some embodiments.

FIG. 2 is a front perspective view of a programmable surface object, in accordance with some embodiments.

FIG. 3 is a front perspective view of the programmable surface object, in accordance with some embodiments.

FIG. 4 is a front perspective view of a programmable surface object, in accordance with some embodiments.

FIG. 5 is a front perspective view of the programmable surface object, in accordance with some embodiments.

FIG. 6 is a front perspective view of the programmable surface object, in accordance with some embodiments.

FIG. 7 is a front perspective view of the programmable surface object, in accordance with some embodiments.

FIG. 8 is a front perspective view of the programmable surface object with at least one first programmable surface object, in accordance with some embodiments.

FIG. 9 is a front perspective view of the programmable surface object with the at least one first programmable surface object, in accordance with some embodiments.

FIG. 10 is a front perspective view of at least one fastener associated with the programmable surface object and at least one first fastener associated with the at least one first programmable surface object, in accordance with some embodiments.

FIG. 11 is a front perspective view of at least one fastener associated with the programmable surface object and at least one first fastener associated with the at least one first programmable surface object, in accordance with some embodiments.

FIG. 12 is a front perspective view of a programmable surface object, in accordance with some embodiments.

FIG. 13 is a front perspective view of a programmable surface object, in accordance with some embodiments.

FIG. 14 is a front perspective view of the programmable surface object, in accordance with some embodiments.

FIG. 15 is a front perspective view of the programmable surface object, in accordance with some embodiments.

FIG. 16 is a front perspective view of the programmable surface object, in accordance with some embodiments.

FIG. 17 is a top view of a programmable surface object with at least one first programmable surface object, in accordance with some embodiments.

FIG. 18 is a top view of the programmable surface object with the at least one first programmable surface object, in accordance with some embodiments.

FIG. 19 is a front perspective view of a programmable surface object, in accordance with some embodiments.

FIG. 20 is a front perspective view of a programmable surface object, in accordance with some embodiments.

FIG. 21 is an illustration of an online platform consistent with various embodiments of the present disclosure.

FIG. 22 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a programmable surface object, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes a programmable surface object. Further, the programmable surface object may include a programmable surface. Further, the programmable surface may include a hard floor, wall, or surface area that can transform into a soft surface area that is capable of absorbing the impact of a person and/or object impacting the programmable surface object.

A floor, wall, or any type of surface built with layers of mechanisms and materials capable of changing a straight/hard/stiff surface into a flexible/soft/springy surface then back to a straight/hard/stiff surface. This programmable surface can absorb different amounts of pressure and/or impact from a human and/or object when making contact with a surface area at various speeds. A programmable surface can be activated in many different ways, without limitation. Below are a few examples, these examples can be used in combination with each other or separately.

One method of transformation includes a user, or someone nearby, who holds and/or communicates with a device. This device activates the programmable surface to change from hard to soft. For example, the user is standing on a programmable surface, a floor, in this case, the user has tripped and is falling to the floor, and the user can signal a device to transform the floor to absorb the impact of the fall, preventing injury. The user has many options to signal the device, for example, pressing a button on a smartphone or voice detection, yelling out, to signal the floor to change from hard to soft.

A second method of transformation includes a computer with specific software and hardware capable of detecting motion or heat, is connected to a programmable surface. Using the same example of a person falling, with motion detection, the user would not have to communicate with a device for activation. Instead, a computer and devices linked to the programmable surface would identify a person falling motion from a regular motion, so when falling, the floor would be automatically transformed for them to absorb the impact of the fall.

A third method of transformation includes sensors that are built into the surface. These sensors can be programmed or set to react to: a selected amount of weight, impact, and/or material. Again using an example of someone falling, the force of the impact from a fall would be different from the force of impact from someone walking. The surface can be programmed or manually set to react to the force of a fall and not the force of a footstep. These sensors could also be used to detect materials, using a technology that could separate the difference between the materials on a person's shoe, to the material or skin that would make contact during a fall.

The construction of a programmable surface can vary, using all different types of materials, sizes, and devices, without limitation. For example, one method of construction would involve many hard connected individual sections for a top layer; these sections would be connected with a link mechanism used to lock them into place with each other. An elastic material is used to allow the individual sections to stretch away from each other when activated. Below the layer of elastic material and connected sections is a layer of soft material capable of absorbing an object's impact.

Support mechanisms are used in this example to balance the hard top layer of connected sections onto the soft layer of material below. Then when activated the support mechanisms release their support of the top layer and the link mechanism used to lock the connected sections into place unlock, allowing the individual hard sections of the top layer that are connected by the stretchable material, to stretch apart from each other and into the soft layer below. Then with the help of the support mechanisms and the method used to lock the sections together, the surface area can transform back into the original hard surface form before the impact.

The design used to connect the hard sections of the top layer can vary, without limitation. One example of construction; a sliding link mechanism attached below each section, with the ability to retract, extend, and lock into the neighboring sections. A second example; a pin or link mechanism that is built into the section itself rather than below, also with the ability to retract, extend, and lock into the neighboring sections. A third example includes a wire or a string like material that is run through each of the sections, which could tighten and loosen when activated. A fourth example would use magnets. All four of these examples could be used in combination with each other or separately.

The design of the support mechanisms used to balance the hard layer of sections onto the soft layer below can vary, without limitation. One example; shock suspension, capable of locking and unlocking. A second example; a support beam capable of retracting electronically or by applied pressure.

The method used to connect the individual linked sections of the top layer to the stretchable material can vary, without limitation. One example would be running the stretchable material over every hard section. Another example would use the material between the cracks. Also, there could be an elastic material under every hard section working in combination with the other two examples.

The material used to create the hard sections of the top layer can vary, along with the size and shape, without limitation. A few examples of materials that could be used include tile, metal, concrete, wood, or plastic. The stretchable material used to connect the sections can also vary, along with the methods used to connect the stretchable material to the hard surface sections used. A few examples of this stretchable material could be; elastic or rubber. The soft material used below the top layer could vary. A few examples could be cotton, foam, springs, coils, gel, water, a trampoline, or pressured air.

Designing a programmable surface with just two layers, a hard layer and a soft layer is just one example of design. Depending on how much impact absorption is needed there could be many hard connected section layers and soft layers on top of each other all working together using customized depths and sizes for each layer. There could also be a final bottom layer or many final bottom layers that are constructed using the same method of connected sections as the top layer. A bottom layer of connected sections would be followed by a layer of support mechanisms rather than a layer of soft material that is used in the top layer design. Another way of design could substitute the soft material used below the top layer of hard sections, with just many absorbing support mechanisms.

All of the different parts in a programmable surface can be connected electronically to work together with each other. A programmable surface could also be designed to work without electricity and both of these methods of design can be used in combination with each other. Also, rather than activation, a programmable surface can be set or built for a specific level of stiffness or absorption. For example, picture a simple wooden board over a soft material like a mattress. The wood will allow a wheel to roll, and the mattress would protect the person from a fall. Now picture several boards and mattresses connected together, the boards being the same size as the mattress. This will allow pressure applied to be distributed to individual sections. The boards can be connected with just an elastic material and/or pins that work either by applied pressure or electronically.

An example of a programmable surface being set to a level of stiffness; having the option to program whether the surface is hard, springy, or absorbing, with different levels for each of these three categories. So a programmable surface could be constructed or programmed to either absorb a person/object or spring a person/object, with the ability to select different levels of resistance for each method. This can be done by using different materials for construction and/or using programmable support/absorbing mechanisms, designed to react differently to all types of pressure, weight, and/or impact.

Another method that may be used for the construction of a programmable surface would use specialized materials, without limitations. Materials that can transform from a hard material to a soft material. For example, a hard stiff plastic, rubber, or gel like material that transforms to a soft, jello like material. Ways of doing this can vary, without limitations. One example would use spaces of air or air pockets inside of a plastic, rubber, or gel like material, so when the surface area is activated, the air pressure inside of this material would change, thus allowing the surface area to change from hard to soft. Another example would use a metal like material in these air pockets so when activated the metal would move to create an open air pocket or space. There could also be a way to use electricity, magnets or other methods that allow a hard material to transform into a soft material.

A programmable surface could be a wall, stairs, ramp, slope, floor, or object, such as a table, bench, railing, or any surface area, without limitation. A programmable surface could also change a surface area into another surface area, without limitation, for example, changing a level floor into a floor that has a 90 degree angle.

A programmable surface could also transform a hard surface area into another style of hard surface area. For example, a floor could start as a basic level flat floor, then one part of this floor could raise up, another part may lower, creating a new surface. Another example would be a staircase that can transform into a floor, and the other way around, a floor that can transform into a staircase.

A programmable surface could also be a surface area that can change the texture. For example, a smooth surface that can change to a rough surface or a smooth surface that can change to an icy or slick surface.

A programmable surface could also be used with a treadmill-like machine, giving the user the ability to walk/run/bike/skate on a surface area that can transform while in a treadmill-like motion while the person stays in the same location.

A programmable surface could also be a surface area that can change to a magnetic surface area.

Using a programmable surface when playing or training for a sport or extreme sport where a hard surface is important and a soft surface could be activated to prevent injury or push the limits of the sport. For example, Skateparks—allowing people to push the limits of extreme sports by being protected from falls on hard surfaces that can change to a soft surface. Hockey—using the technology in the boards alongside the ice, to prevent similar accidents that have happened in the past, where players have been paralyzed from hitting the boards wrong. Basketball—a person falling on the court, or used for fun, a person being able to spring into the air and perform a dunk, on a surface that can change from a hard regular surface on a basketball court to trampoline-like surface area. Football—having programmable surfaces under a grassy surface to help protect a person when being tackled. Baseball—jumping in the air to catch a ball and protecting the person when they fall. Having in the home to help protect children, the elderly, the disabled, or anyone from falling downstairs, in the shower, or other areas of the home. In areas such as playgrounds or walkways to protect children and people from injury when falling. Preventing on-the-job injuries in a warehouse or areas where workers performing various tasks could fall. Having a programmable surface to help protect objects from being damaged during use or manufacturing. Virtual reality or gaming, using a programmable surface connected to video screens and even a treadmill. Driver safety, building objects around roadways with programmable surface absorption ability or using in the actual design of a vehicle.

Further, the programmable surface may be implemented by a tile design and a rubber design. Further, the tile design may require tiles. Further, the tiles are connected using connection methods. Further, the connection methods may include pin systems, magnets, string systems. Further, the tile design may include absorption devices that are used underneath the programmable surface. Further, the absorption devices may include shocks, robot arms, pressured air and water that can be controlled to release pressure, and steel beams and springs. Further, the steel beams move the springs take over. Further, the tile design may include non electrical designs, elastic/tile/spring designs, and mousetrap designs. The elastic/tile/spring designs do not require connecting pins, just tiles connected with elastic and springs underneath. The mousetrap designs use shocks and connecting pins that are controlled by pressure and not computers.

Further, the rubber design may include steel beams and rubber which would use steel beams that could work as individual beams or groups of connected beams. Further, the rubber design may include a mousetrap design. The mousetrap design work using steel beams that are controlled by pressure and not computers. Further, the rubber design may include gel ice packs that are underneath the programmable surface. Further, the rubber design may include plastic that is underneath the programmable surface. This plastic can transform into an elastic material. Further, the programmable surface may include the overlapping feature. Further, the programmable surface is activated using many activation methods.

The programmable surface is programmable between an absorbing surface to a spring surface and different levels for each setting.

The programmable surface is programmable to react differently to different types of impact and/or pressure applied.

The programmable surface could be a wall, stairs, ramp, slope, floor, or object, such as a table, bench, railing, or any kind of surface area

The programmable surface is transformable. For example, changing a level floor to a floor with an angle

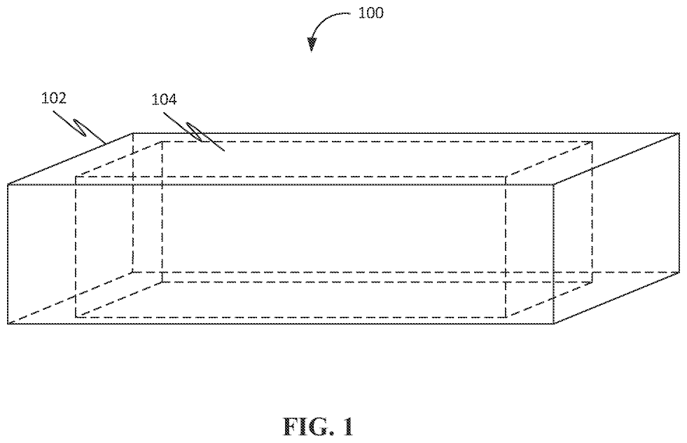

FIG. 1 is a front perspective view of a programmable surface object 100, in accordance with some embodiments. Accordingly, the programmable surface object 100 may include a structure 102 and a plurality of variable compressibility elements 104. Further, the structure 102 may be comprised of at least one material. Further, the structure 102 may include a tile structure, a panel structure, a block structure, etc. Further, the plurality of variable compressibility elements 104 may be configured for allowing compressing of the structure 102 to one of a plurality of compression levels corresponding to one of a plurality of energy stimuli received by the plurality of variable compressibility elements 104. Further, the plurality of energy stimuli may include a pressure stimulus, a temperature stimulus, an electrical stimulus, a magnetic stimulus, a stress stimulus, a humidity stimulus, etc. Further, the compressing of the structure 102 allows deforming of the programmable surface object 100 to one of a plurality of deforming degrees. Further, the deforming of the programmable surface object 100 allows the programmable surface object 100 to absorb one or more impacts.

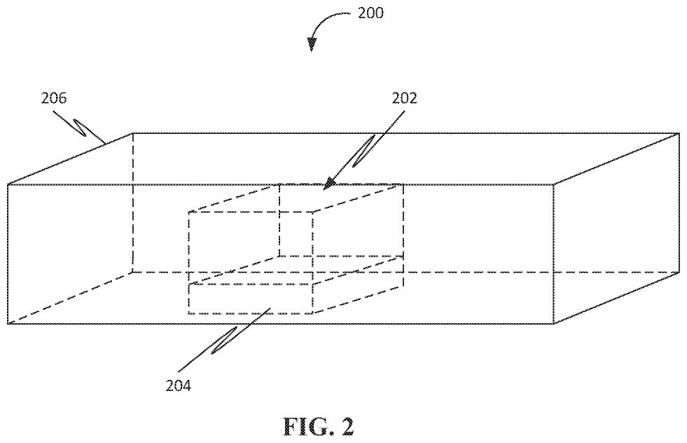

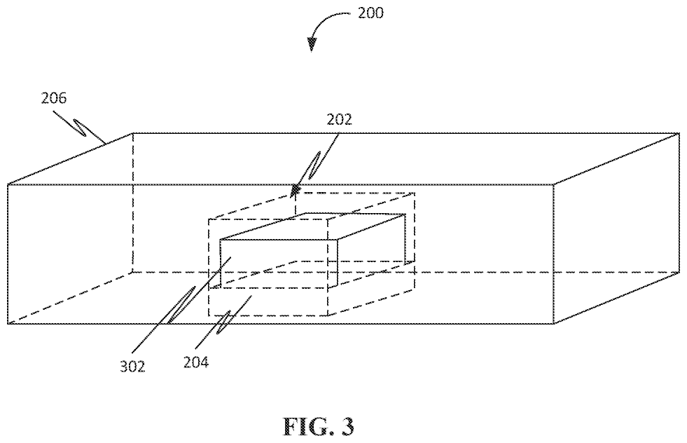

Further, in some embodiments, the structure 102 may include at least one cavity 202, as shown in FIG. 2. Further, the plurality of variable compressibility elements 104 may include at least one material 302, as shown in FIG. 3, and at least one inserting device 204, as shown in FIG. 2. Further, the at least one material 302 may include at least one metal rod, at least one gas, at least one liquid, etc. Further, the at least one inserting device 204 may be coupled with the at least one cavity 202. Further, the at least one inserting device 204 may be configured for removably inserting the at least one material 302 in the at least one cavity 202 in one of a plurality of amounts based on one of a plurality of electrical energy stimuli of the plurality of energy stimuli received by the at least one inserting device 204. Further, the allowing of the compressing of the structure 102 to one of the plurality of compression levels may be based on the removably inserting of the at least one material 302 in the at least one cavity 202 in one of the plurality of amounts.

Further, in some embodiments, the plurality of variable compressibility elements 104 may include at least one material. Further, the at least one material may include electrorheological fluids, Bingham plastic, etc. Further, the at least one material may be disposed in the structure 102. Further, the at least one material may be configured for compressing to one of the plurality of compression levels based on one of the plurality of energy stimuli received by the at least one material. Further, the allowing of the compressing of the structure 102 may be based on the compressing of the at least one material.

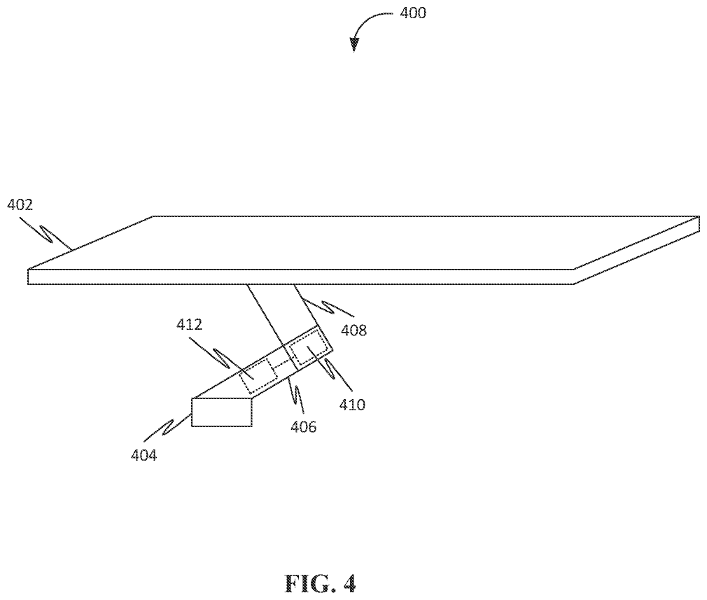

Further, in some embodiments, the structure 102 may include a panel 402, as shown in FIG. 4. Further, the plurality of variable compressibility elements 104 may include a movable arm 404 and at least one actuator 412, as shown in FIG. 4. Further, the at least one actuator 412 may include an electric motor. Further, the movable arm 404 may include a base arm section 406 and a movable arm section 408. Further, a first end of the movable arm section 408 may be movably coupled with the base arm section 406 using at least one movement mechanism 410 and a second end of the movable arm section 408 may be attached to the panel 402. Further, the at least one movement mechanism 410 allows the movable arm section 408 for moving through a plurality of arm positions. Further, the at least one actuator 412 may be coupled with the at least one movement mechanism 410. Further, the at least one actuator 412 may be configured for actuating the at least one movement mechanism 410 for moving the movable arm section 408 to one of the plurality of arm positions based on one of a plurality of electrical energy stimuli of the plurality of energy stimuli received by the at least one actuator 412. Further, one of the plurality of arm positions corresponds to one of the plurality of compression levels.

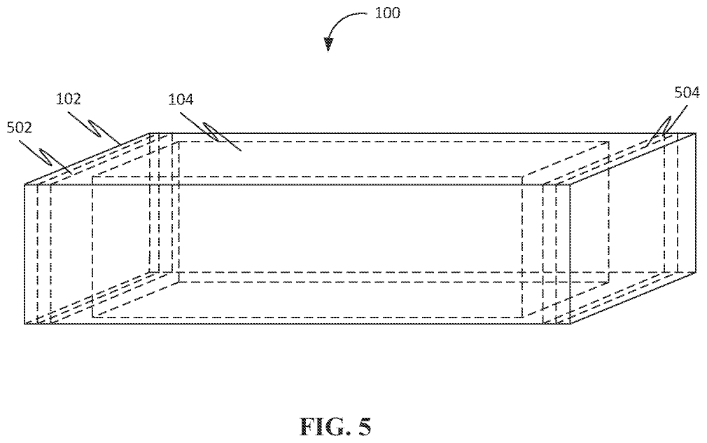

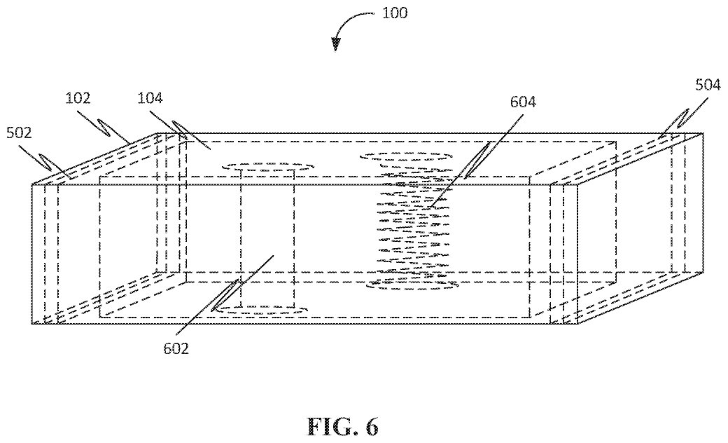

Further, in some embodiments, the structure 102 may include at least one structure lock mechanism 502-504, as shown in FIG. 5. Further, the plurality of variable compressibility elements 104 may include at least one absorption device 602-604, as shown in FIG. 6. Further, the at least one structure lock mechanism 502-504 may be configured for transitioning the structure 102 from a structure locked state and a structure unlocked state. Further, the structure 102 allows transferring of one of the plurality of energy stimuli to the at least one absorption device 602-604 in the structure unlocked state. Further, allowing of the transferring of the plurality of energy stimuli to the at least one absorption device 602-604 elastically deforms the at least one absorption device 602-604 to one of a plurality of degrees corresponding to one of the plurality of energy stimuli. Further, the allowing of the compressing of the structure 102 may be based on the allowing of the transferring. Further, the structure 102 prevents the transferring of one of the plurality of energy stimuli to the at least one absorption device 602-604 in the structure locked state. Further, preventing of the transferring of the plurality of energy stimuli to the at least one absorption device 602-604 does not elastically deform the at least one absorption device 602-604 to one of the plurality of degrees.

Further, in an embodiment, the transitioning of the structure 102 from the structure locked state to the structure unlocked state may be based on at least one threshold energy stimulus receivable by the structure 102. Further, one of the plurality of energy stimuli may be greater than the at least one threshold energy stimulus.

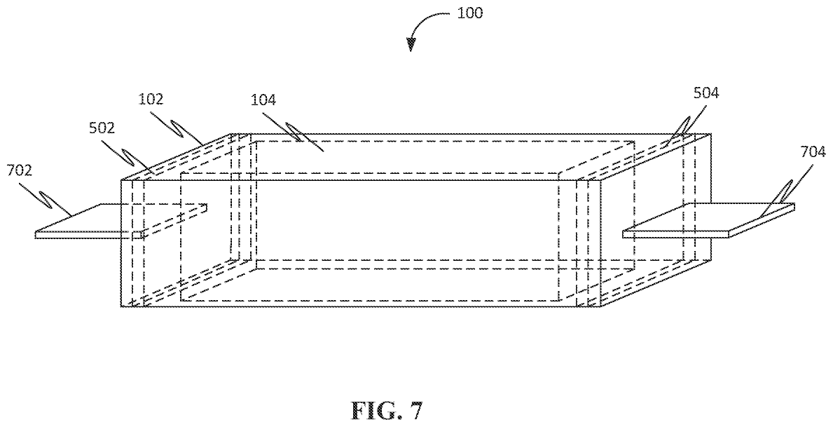

Further, in an embodiment, the structure 102 may include at least one linking element 702-704, as shown in FIG. 7. Further, the at least one linking element 702-704 connects the structure 102 to at least one first structure 804. Further, the at least one linking element 702-704 may be transitionable between a moving link state and a static link state. Further, the structure 102 may be movable in relation to the at least one first structure 804 in the moving link state. Further, the structure 102 may be not movable in relation to the at least one first structure 804 in the static link state. Further, the at least one structure lock mechanism 502-504 may be coupled with the at least one linking element 702-704. Further, the at least one structure lock mechanism 502-504 transitions the at least one linking element 702-704 to the static link state from the moving link state in the structure locked state. Further, the at least one structure lock mechanism 502-504 transitions the at least one linking element 702-704 to the moving link state from the static link state in the structure unlocked state.

Further, in an embodiment, the at least one linking element 702-704 may include at least one elastically deformable linking element. Further, the at least one elastically deformable linking element elastically deforms in the moving link state allowing the structure 102 to move in relation to the at least one first structure 804. Further, the at least one elastically deformable linking element does not elastically deform in the static link state preventing the structure 102 to move in relation to the at least one first structure 804.

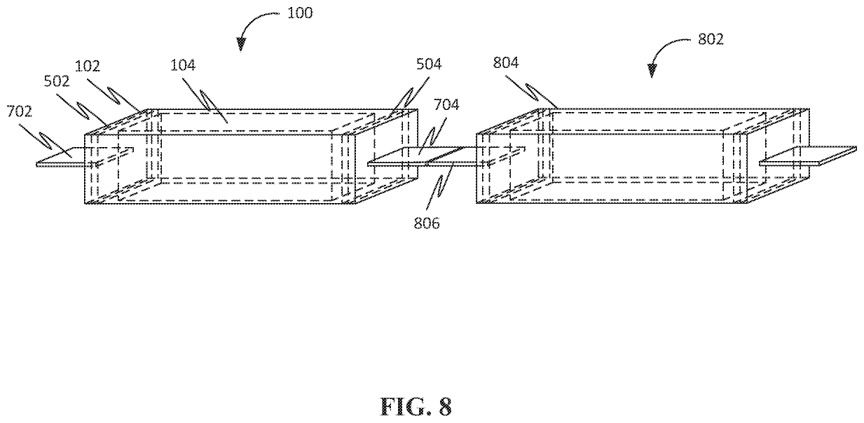

Further, in an embodiment, the at least one linking element 702-704 detachably connects the structure 102 to the at least one first structure 804. Further, the at least one linking element 702-704 may include at least one fastener disposed on a distal end of the at least one linking element 702-704. Further, the at least one linking element 702-704 extends away from the structure 102. Further, the at least one fastener may be detachably fastenable to at least one first fastener of at least one first linking element 806, as shown in FIG. 8, comprised in the at least one first structure 804. Further, the at least one fastener fastens to the at least one first fastener for connecting the structure 102 to the at least one first structure 804. Further, the at least one fastener detaches from the at least one first fastener for detaching the structure 102 from the at least one first structure 804.

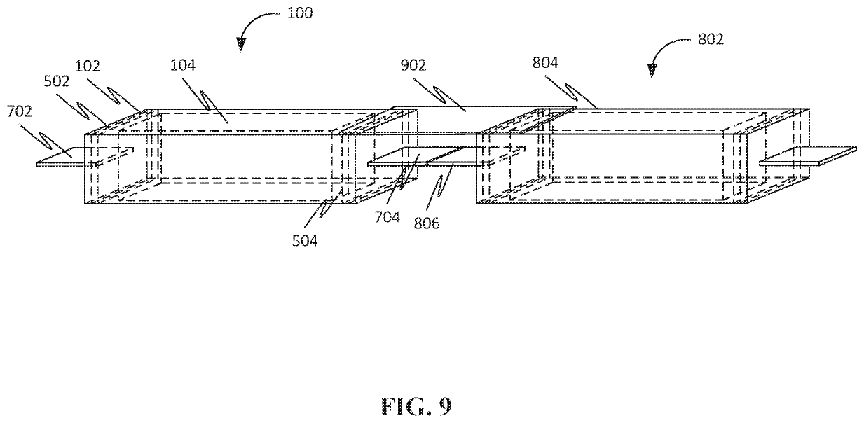

Further, in an embodiment, the at least one first structure 804 may be associated with at least one first programmable surface object 802. Further, the connecting of the structure 102 with the at least one first structure 804 connects the programmable surface object 100 to the at least one first programmable surface object 802. Further, the disconnecting of the structure 102 from the at least one first structure 804 disconnects the programmable surface object 100 to the at least one first programmable surface object 802. Further, in an embodiment, the at least one linking element 702-704 may be comprised in one or more sides of the structure 102 and the at least one first linking element 806 may be comprised in one or more first sides of the at least one first structure 804. Further, the structure 102 may include one or more overlapping structure portions 902, as shown in FIG. 9, extending laterally from the one or more sides of the structure 102 over the at least one linking element 702-704. Further, the one or more overlapping structure portions 902 may be disposable on one or more first structure portions of the at least one first structure 804 based on the connecting of the structure 102 with the at least one first structure 804 for covering the at least one linking element 702-704 and the at least one first linking element 806. Further, disposing of the one or more overlapping structure portions 902 over the one or more structure portions form a continuous surface on a top side of the programmable surface object 100 and the at least one first programmable surface object 802.

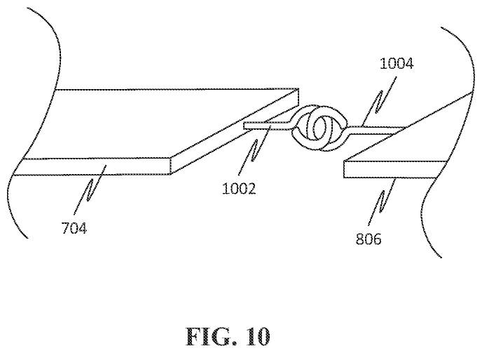

Further, in an embodiment, the at least one fastener may include at least one hook 1002, as shown in FIG. 10. Further, the at least one first fastener may include at least one catch 1004, as shown in FIG. 10. Further, the at least one hook 1002 may be removably latchable to the at least one catch 1004. Further, the at least one hook 1002 latches to the at least one catch 1004 for connecting the structure 102 to the at least one first structure 804. Further, the at least one hook 1002 removes from the at least one catch 1004 for detaching the structure 102 from the at least one first structure 804.

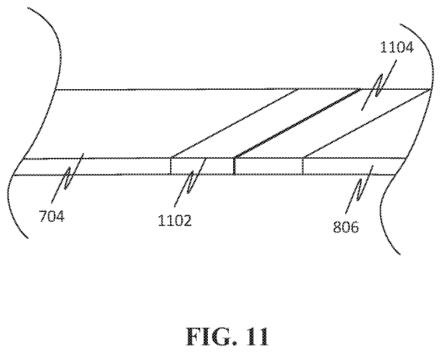

Further, in an embodiment, the at least one fastener may include at least one magnetic element 1102, as shown in FIG. 11. Further, the at least one first fastener may include at least one first magnetic element 1104, as shown in FIG. 11. Further, the at least one magnetic element 1102 may be magnetically detachably attachable to the at least one first magnetic element 1104. Further, the at least one magnetic element 1102 magnetically attaches to the at least one first magnetic element 1104 for connecting the structure 102 to the at least one first structure 804. Further, the at least one magnetic element 1102 magnetically detaches from the at least one first magnetic element 1104 for detaching the structure 102 from the at least one first structure 804.

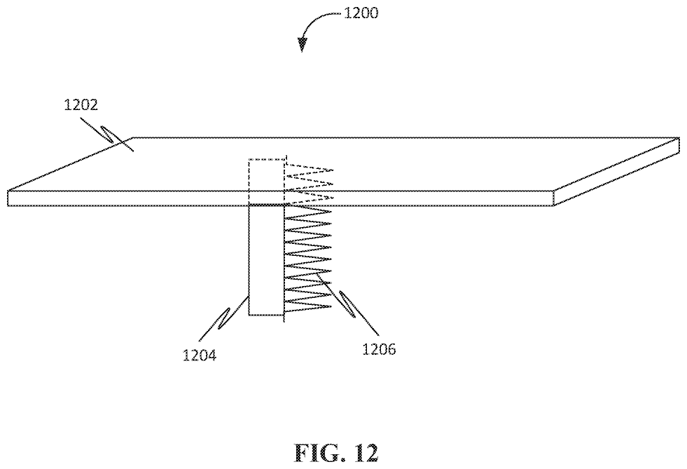

Further, in some embodiments, the structure 102 may include a panel 1202, as shown in FIG. 12. Further, the plurality of variable compressibility elements 104 may include at least one locking mechanism 1204 and at least one spring 1206, as shown in FIG. 12. Further, a base end of the at least one spring 1206 may be disposable on at least one surface and a top end of the at least one spring 1206 may be interfacable with the panel 1202. Further, the at least one locking mechanism 1204 may be configurable for transitioning between an unlocked state and a locked state. Further, the at least one spring 1206 may be configurable for transitioning between an extended spring state and at least one compressed spring state corresponding to one of the plurality of energy stimuli receivable by the at least one spring 1206 through the panel 1202. Further, the at least one locking mechanism 1204 may be configured for unlockably locking the at least one spring 1206 based on the transitioning of the at least one locking mechanism 1204 between the locked state and the unlocked state. Further, the at least one locking mechanism 1204 unlocks the at least one spring 1206 in the unlocked state allowing the transitioning of the at least one spring 1206 between the extended spring state and the at least one compressed spring state for allowing the compressing of the structure 102. Further, the at least one locking mechanism 1204 locks the at least one spring 1206 in the locked state preventing the transitioning of the at least one spring 1206 between the extended spring state and the at least one compressed spring state for preventing the compressing of the structure 102.

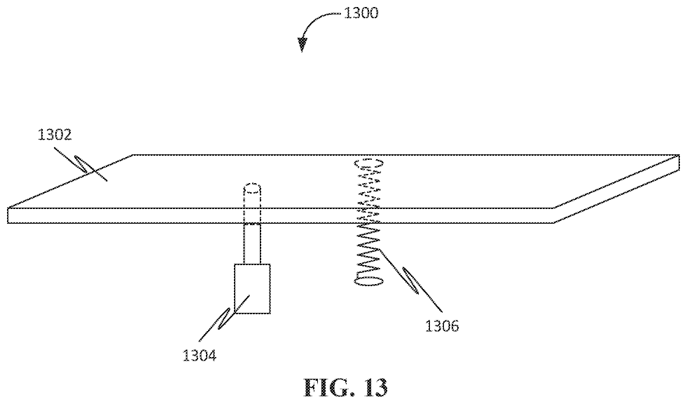

Further, in some embodiments, the structure 102 may include a panel 1302, as shown in FIG. 13. Further, the plurality of variable compressibility elements 104 may include at least one rigid support 1304 and at least one spring 1306, as shown in FIG. 13. Further, a base end of the at least rigid support and the at least one spring 1306 may be disposable on at least one surface and a top end of the at least one rigid support 1304 and the at least one spring 1306 may be interfacable with the panel 1302. Further, the at least one rigid support 1304 may be configurable for transitioning between an extended state and at least one retracted state. Further, the at least one rigid support 1304 may be configured for supporting the panel 1302 in the extended state preventing the compressing of the structure 102. Further, the at least one rigid support 1304 does not support the panel 1302 in the at least one retracted state allowing the compressing of the structure 102. Further, the at least one spring 1306 may be configurable for transitioning between an extended spring state and at least one compressed spring state. Further, a support length of the at least one rigid support 1304 in the extended state may be greater than a spring length of the at least one spring 1306 in the extended spring state and the support length of the at least one rigid support 1304 in the at least one retracted state may be smaller than the spring length of the at least one spring 1306 in the at least one retracted state. Further, the at least one rigid support 1304 prevents interfacing of the at least one spring 1306 with the at least one programmable surface for preventing receiving of one of the plurality of energy stimuli by the at least one spring 1306 through the panel 1302 in the extended state. Further, the preventing of the receiving of one of the plurality of energy stimuli prevents the transitioning of the at least one spring 1306 to the at least one compressed spring state from the extended spring state. Further, preventing the transitioning prevents the compressing of the structure 102. Further, the at least one rigid support 1304 allows interfacing of the at least one spring 1306 with the panel 1302 for allowing the receiving of one of the plurality of energy stimuli by the at least one spring 1306 through the panel 1302 in the at least one retracted state. Further, the allowing of the receiving of one of the plurality of energy stimuli allows the transitioning of the at least one spring 1306 to the at least one compressed spring state from the extended spring state. Further, allowing the transitioning allows the compressing of the structure 102.

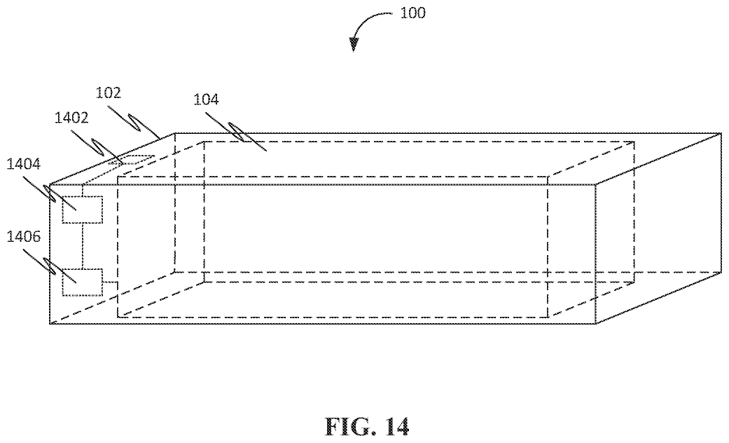

Further, in some embodiments, the programmable surface object 100 may include at least one first sensor 1402, a processing device 1404, and at least one stimulus providing device 1406, as shown in FIG. 14. Further, the at least one first sensor 1402 may be disposed on the structure 102. Further, the at least one first sensor 1402 may be configured for generating at least one first sensor data based on at least one physical state of the structure 102. Further, the at least one physical state a pressure, a temperature, etc. Further, the processing device 1404 may be communicatively coupled with the at least one first sensor 1402. Further, the processing device 1404 may be configured for analyzing the at least one first sensor data. Further, the processing device 1404 may be configured for determining at least one first trigger condition for the allowing of the compressing of the structure 102 to one of the plurality of compression levels based on the analyzing. Further, the processing device 1404 may be configured for generating at least one first compressing command based on the determining. Further, the at least one stimulus providing device 1406 may be communicatively coupled with the processing device 1404. Further, the at least one stimulus providing device 1406 may be coupled with the plurality of variable compressibility elements 104. Further, the at least one stimulus providing device 1406 may be configured for providing one of the plurality of energy stimuli to the plurality of variable compressibility elements 104 based on the at least one first compressing command. Further, the allowing of the compressing of the structure 102 to one of the plurality of compression levels may be based on the providing.

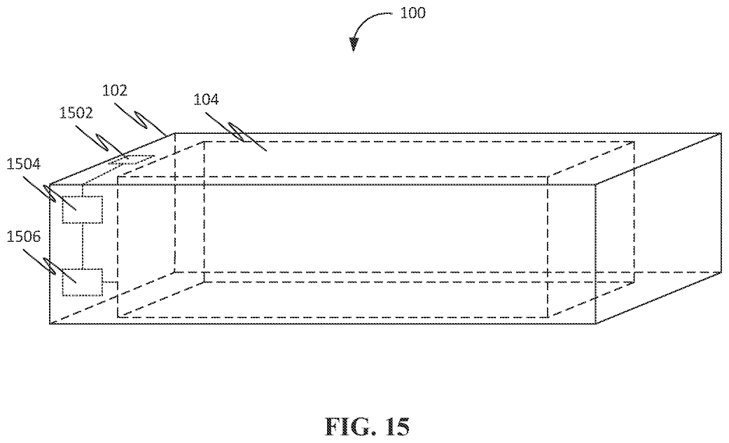

Further, in some embodiments, the programmable surface object 100 may include at least one second sensor 1502, a processing device 1504, and at least one stimulus providing device 1506, as shown in FIG. 15. Further, the at least one second sensor 1502 may be disposed on the structure 102. Further, the at least one second sensor 1502 may be configured for generating at least one second sensor data based on at least one interaction between the structure 102 and at least one object. Further, the processing device 1504 may be communicatively coupled with the at least one second sensor 1502. Further, the processing device 1504 may be configured for analyzing the at least one second sensor data. Further, the processing device 1504 may be configured for determining at least one second trigger condition for the allowing of the compressing of the structure 102 to one of the plurality of compression levels based on the analyzing. Further, the processing device 1504 may be configured for generating at least one second compressing command based on the determining. Further, the at least one stimulus providing device 1506 may be communicatively coupled with the processing device 1504. Further, the at least one stimulus providing device 1506 may be coupled with the plurality of variable compressibility elements 104. Further, the at least one stimulus providing device 1506 may be configured for providing one of the plurality of energy stimuli to the plurality of variable compressibility elements 104 based on the at least one second compressing command. Further, the allowing of the compressing of the structure 102 to one of the plurality of compression levels may be based on the providing.

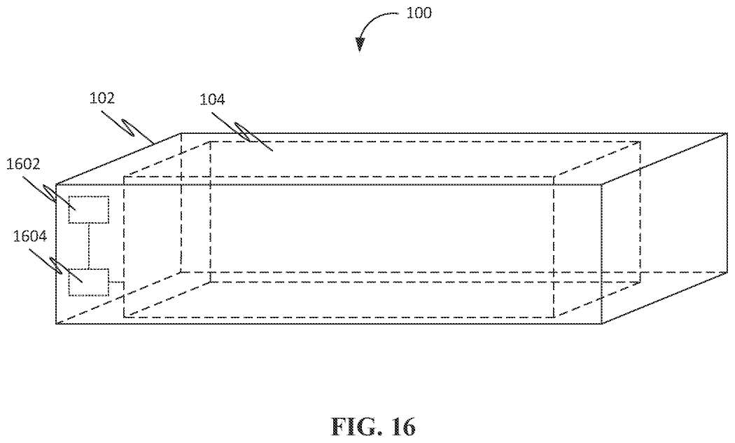

Further, in some embodiments, the programmable surface object 100 may include a communication device 1602 and at least one stimulus providing device 1604, as shown in FIG. 16. Further, the communication device 1602 may be configured for receiving at least one third compressing command from at least one input device. Further, the at least one stimulus providing device 1604 may be communicatively coupled with the communication device 1602. Further, the at least one stimulus providing device 1604 may be coupled with the plurality of variable compressibility elements 104. Further, the at least one stimulus providing device 1604 may be configured for providing one of the plurality of energy stimuli to the plurality of variable compressibility elements 104 based on the at least one third compressing command. Further, the allowing of the compressing of the structure 102 to one of the plurality of compression levels may be based on the providing.

FIG. 2 is a front perspective view of a programmable surface object 200, in accordance with some embodiments. Further, the programmable surface object 200 may include a structure 206 and a plurality of variable compressibility elements. Further, the structure 206 may include the at least one cavity 202. Further, the plurality of variable compressibility elements may include the at least one material and the at least one inserting device 204.

FIG. 3 is a front perspective view of the programmable surface object 200, in accordance with some embodiments.

FIG. 4 is a front perspective view of a programmable surface object 400, in accordance with some embodiments. Further, the programmable surface object 400 may include the panel 402, the movable arm 404, and the at least one actuator 412.

FIG. 5 is a front perspective view of the programmable surface object 100, in accordance with some embodiments.

FIG. 6 is a front perspective view of the programmable surface object 100, in accordance with some embodiments.

FIG. 7 is a front perspective view of the programmable surface object 100, in accordance with some embodiments.

FIG. 8 is a front perspective view of the programmable surface object 100 with at least one first programmable surface object 802, in accordance with some embodiments.

FIG. 9 is a front perspective view of the programmable surface object 100 with the at least one first programmable surface object 802, in accordance with some embodiments.

FIG. 10 is a front perspective view of at least one fastener associated with the programmable surface object 100 and at least one first fastener associated with the at least one first programmable surface object 802, in accordance with some embodiments.

FIG. 11 is a front perspective view of at least one fastener associated with the programmable surface object 100 and at least one first fastener associated with the at least one first programmable surface object 802, in accordance with some embodiments.

FIG. 12 is a front perspective view of a programmable surface object 1200, in accordance with some embodiments. Further, the programmable surface object 1200 may include the panel 1202, the at least one locking mechanism 1204, and the at least one spring 1206.

FIG. 13 is a front perspective view of a programmable surface object 1300, in accordance with some embodiments. Further, the programmable surface object 1300 may include the panel 1302, the at least one rigid support 1304, and the at least one spring 1306.

FIG. 14 is a front perspective view of the programmable surface object 100, in accordance with some embodiments.

FIG. 15 is a front perspective view of the programmable surface object 100, in accordance with some embodiments.

FIG. 16 is a front perspective view of the programmable surface object 100, in accordance with some embodiments.

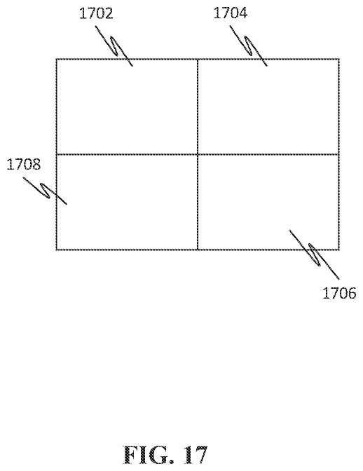

FIG. 17 is a top view of a programmable surface object 1702 with at least one first programmable surface object 1704-1708, in accordance with some embodiments.

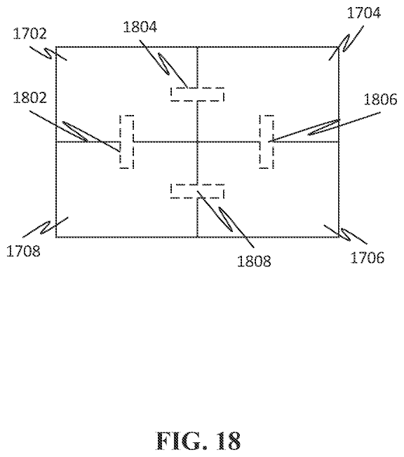

FIG. 18 is a top view of the programmable surface object 1702 with the at least one first programmable surface object 1704-1708, in accordance with some embodiments. Further, the programmable surface object 1702 and the at least one first programmable surface object 1704-1708 may be connected using at least one linking element 1802-1808. Further, the at least one linking element 1802-1808 may be transitionable between a moving link state and a static link state. Further, the at least one linking elements 1802-1808 may lock the programmable surface object 1702 with the at least one first programmable surface object 1704-1708 into a place with each other. Further, the at least one linking element 1802-1808 may unlock the programmable surface object 1702 from the at least one first programmable surface object 1704-1708 allowing the programmable surface object 1702 and the at least one first programmable surface object 1704-1708 to stretch apart from each other.

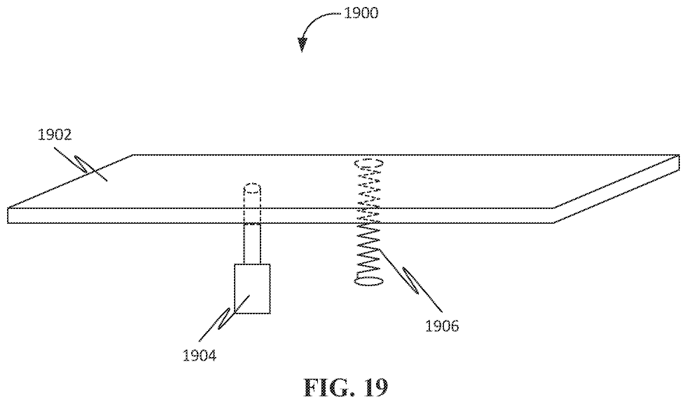

FIG. 19 is a front perspective view of a programmable surface object 1900, in accordance with some embodiments. Accordingly, the programmable surface object 1900 may include a structure 1902 and a plurality of variable compressibility elements 1904-1906. Further, the plurality of variable compressibility elements 1904-1906 may be configured for allowing compressing of the structure 1902 to one of a plurality of compression levels corresponding to one of a plurality of energy stimuli received by the plurality of variable compressibility elements 1904-1906. Further, the compressing of the structure 1902 allows deforming of the programmable surface object 1900 to one of a plurality of deforming degrees. Further, the structure 1902 may include a panel. Further, the plurality of variable compressibility elements 1904-1906 may include at least one rigid support and at least one spring. Further, a base end of the at least rigid support and the at least one spring may be disposable on at least one surface and a top end of the at least one rigid support and the at least one spring may be interfacable with the panel. Further, the at least one rigid support may be configurable for transitioning between an extended state and at least one retracted state. Further, the at least one rigid support may be configured for supporting the panel in the extended state preventing the compressing of the structure 1902. Further, the at least one rigid support does not support the panel in the at least one retracted state allowing the compressing of the structure 1902. Further, the at least one spring may be configurable for transitioning between an extended spring state and at least one compressed spring state. Further, a support length of the at least one rigid support in the extended state may be greater than a spring length of the at least one spring in the extended spring state and the support length of the at least one rigid support in the at least one retracted state may be smaller than the spring length of the at least one spring in the at least one retracted state. Further, the at least one rigid support prevents interfacing of the at least one spring with the at least one programmable surface for preventing receiving of one of the plurality of energy stimuli by the at least one spring through the panel in the extended state. Further, the preventing of the receiving of one of the plurality of energy stimuli prevents the transitioning of the at least one spring to the at least one compressed spring state from the extended spring state. Further, preventing the transitioning prevents the compressing of the structure 1902. Further, the at least one rigid support allows interfacing of the at least one spring with the panel for allowing the receiving of one of the plurality of energy stimuli by the at least one spring through the panel in the at least one retracted state. Further, the allowing of the receiving of one of the plurality of energy stimuli allows the transitioning of the at least one spring to the at least one compressed spring state from the extended spring state. Further, allowing the transitioning allows the compressing of the structure 1902.

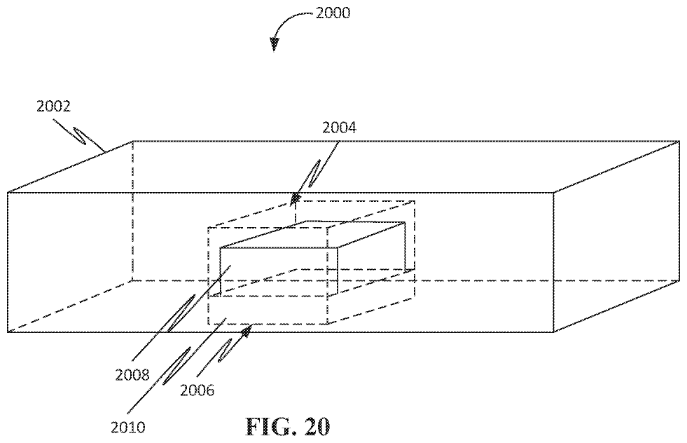

FIG. 20 is a front perspective view of a programmable surface object 2000, in accordance with some embodiments. Accordingly, the programmable surface object 2000 may include a structure 2002 and a plurality of variable compressibility elements 2006. Further, the plurality of variable compressibility elements 2006 may be configured for allowing compressing of the structure 2002 to one of a plurality of compression levels corresponding to one of a plurality of energy stimuli received by the plurality of variable compressibility elements 2006. Further, the compressing of the structure 2002 allows deforming of the programmable surface object 2000 to one of a plurality of deforming degrees. Further, the structure 2002 may include at least one cavity 2004. Further, the plurality of variable compressibility elements 2006 may include at least one material 2006 and at least one inserting device 2010. Further, the at least one inserting device 2010 may be coupled with the at least one cavity 2004. Further, the at least one inserting device 2010 may be configured for removably inserting the at least one material 2006 in the at least one cavity 2004 in one of a plurality of amounts based on one of a plurality of electrical energy stimuli of the plurality of energy stimuli received by the at least one inserting device 2010. Further, the allowing of the compressing of the structure 2002 to one of the plurality of compression levels may be based on the removably inserting of the at least one material 2006 in the at least one cavity 2004 in one of the plurality of amounts.

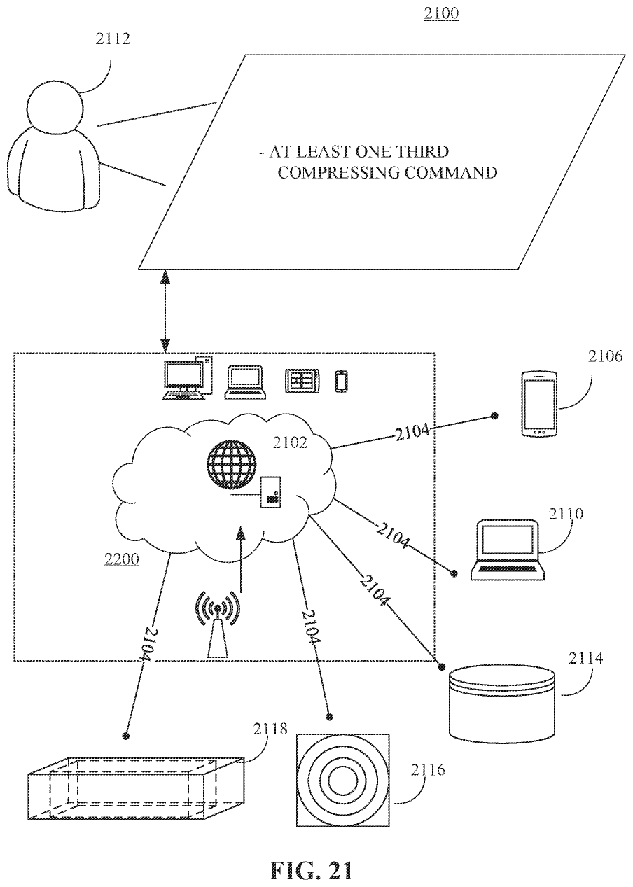

FIG. 21 is an illustration of an online platform 2100 consistent with various embodiments of the present disclosure. By way of non-limiting example, the online platform 2100 to facilitate compressing of a programmable surface object may be hosted on a centralized server 2102, such as, for example, a cloud computing service. The centralized server 2102 may communicate with other network entities, such as, for example, a mobile device 2106 (such as a smartphone, a laptop, a tablet computer, etc.), other electronic devices 2110 (such as desktop computers, server computers, etc.), databases 2114, sensors 2116, and a programmable surface object 2118 (such as the programmable surface object 100) over a communication network 2104, such as, but not limited to, the Internet. Further, users of the online platform 2100 may include relevant parties such as, but not limited to, end-users, administrators, service providers, service consumers, and so on. Accordingly, in some instances, electronic devices operated by the one or more relevant parties may be in communication with the platform.

A user 2112, such as the one or more relevant parties, may access online platform 2100 through a web based software application or browser. The web based software application may be embodied as, for example, but not be limited to, a website, a web application, a desktop application, and a mobile application compatible with a computing device 2200.

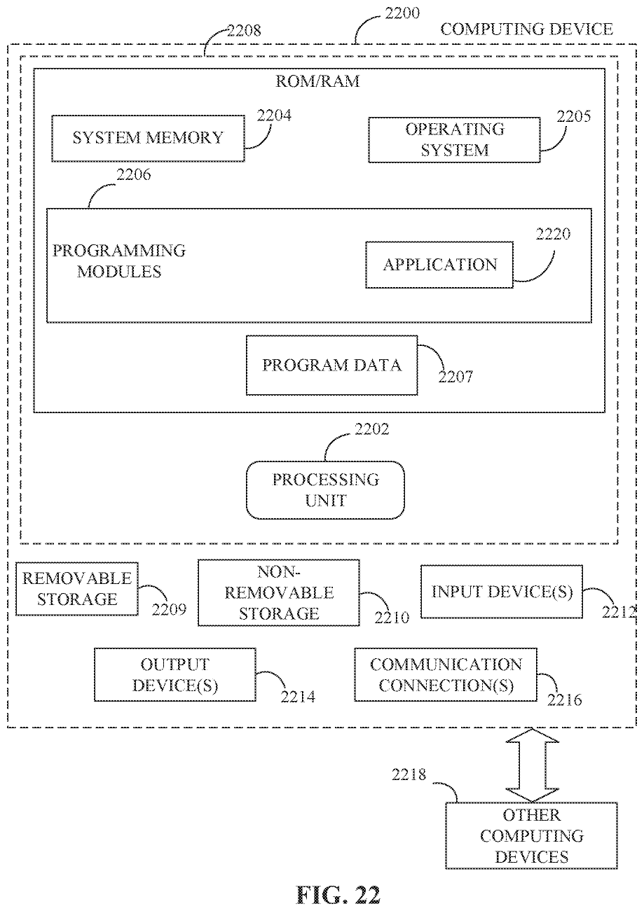

With reference to FIG. 22, a system consistent with an embodiment of the disclosure may include a computing device or cloud service, such as computing device 2200. In a basic configuration, computing device 2200 may include at least one processing unit 2202 and a system memory 2204. Depending on the configuration and type of computing device, system memory 2204 may comprise, but is not limited to, volatile (e.g. random-access memory (RAM)), non-volatile (e.g. read-only memory (ROM)), flash memory, or any combination. System memory 2204 may include operating system 2205, one or more programming modules 2206, and may include a program data 2207. Operating system 2205, for example, may be suitable for controlling computing device 2200's operation. In one embodiment, programming modules 2206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 22 by those components within a dashed line 2208.

Computing device 2200 may have additional features or functionality. For example, computing device 2200 may also include additional data storage devices (removable and/or non-removable) such as, for example, magnetic disks, optical disks, or tape. Such additional storage is illustrated in FIG. 22 by a removable storage 2209 and a non-removable storage 2210. Computer storage media may include volatile and non-volatile, removable and non-removable media implemented in any method or technology for storage of information, such as computer-readable instructions, data structures, program modules, or other data. System memory 2204, removable storage 2209, and non-removable storage 2210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2200. Any such computer storage media may be part of device 2200. Computing device 2200 may also have input device(s) 2212 such as a keyboard, a mouse, a pen, a sound input device, a touch input device, a location sensor, a camera, a biometric sensor, etc. Output device(s) 2214 such as a display, speakers, a printer, etc. may also be included. The aforementioned devices are examples and others may be used.

Computing device 2200 may also contain a communication connection 2216 that may allow device 2200 to communicate with other computing devices 2218, such as over a network in a distributed computing environment, for example, an intranet or the Internet. Communication connection 2216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2204, including operating system 2205. While executing on processing unit 2202, programming modules 2206 may perform processes including, for example, one or more stages of methods, algorithms, systems, applications, servers, databases as described above. The aforementioned process is an example, and processing unit 2202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A programmable surface object comprising:
a structure; and
a plurality of variable compressibility elements configured for allowing compressing of the structure to one of a plurality of compression levels corresponding to one of a plurality of energy stimuli received by the plurality of variable compressibility elements, wherein the compressing of the structure allows deforming of the programmable surface object to one of a plurality of deforming degrees.

2. The programmable surface object of claim 1, wherein the structure comprises at least one cavity, wherein the plurality of variable compressibility elements comprises at least one material and at least one inserting device, wherein the at least one inserting device is coupled with the at least one cavity, wherein the at least one inserting device is configured for removably inserting the at least one material in the at least one cavity in one of a plurality of amounts based on one of a plurality of electrical energy stimuli of the plurality of energy stimuli received by the at least one inserting device, wherein the allowing of the compressing of the structure to one of the plurality of compression levels is based on the removably inserting of the at least one material in the at least one cavity in one of the plurality of amounts.

3. The programmable surface object of claim 1, wherein the plurality of variable compressibility elements comprises at least one material, wherein the at least one material is disposed in the structure, wherein the at least one material is configured for compressing to one of the plurality of compression levels based on one of the plurality of energy stimuli received by the at least one material, wherein the allowing of the compressing of the structure is based on the compressing of the at least one material.

4. The programmable surface object of claim 1, wherein the structure comprises a panel, wherein the plurality of variable compressibility elements comprises a movable arm and at least one actuator, wherein the movable arm comprises a base arm section and a movable arm section, wherein a first end of the movable arm section is movably coupled with the base arm section using at least one movement mechanism and a second end of the movable arm section is attached to the panel, wherein the at least one movement mechanism allows the movable arm section for moving through a plurality of arm positions, wherein the at least one actuator is coupled with the at least one movement mechanism, wherein the at least one actuator is configured for actuating the at least one movement mechanism for moving the movable arm section to one of the plurality of arm positions based on one of a plurality of electrical energy stimuli of the plurality of energy stimuli received by the at least one actuator, wherein one of the plurality of arm positions corresponds to one of the plurality of compression levels.

5. The programmable surface object of claim 1, wherein the structure comprises at least one structure lock mechanism, wherein the plurality of variable compressibility elements comprises at least one absorption device, wherein the at least one structure lock mechanism is configured for transitioning the structure from a structure locked state and a structure unlocked state, wherein the structure allows transferring of one of the plurality of energy stimuli to the at least one absorption device in the structure unlocked state, wherein allowing of the transferring of the plurality of energy stimuli to the at least one absorption device elastically deforms the at least one absorption device to one of a plurality of degrees corresponding to one of the plurality of energy stimuli, wherein the allowing of the compressing of the structure is based on the allowing of the transferring, wherein the structure prevents the transferring of one of the plurality of energy stimuli to the at least one absorption device in the structure locked state, wherein preventing of the transferring of the plurality of energy stimuli to the at least one absorption device does not elastically deform the at least one absorption device to one of the plurality of degrees.

6. The programmable surface object of claim 5, wherein the transitioning of the structure from the structure locked state to the structure unlocked state is based on at least one threshold energy stimulus receivable by the structure, wherein one of the plurality of energy stimuli is greater than the at least one threshold energy stimulus.

7. The programmable surface object of claim 5, wherein the structure comprises at least one linking element, wherein the at least one linking element connects the structure to at least one first structure, wherein the at least one linking element is transitionable between a moving link state and a static link state, wherein the structure is movable in relation to the at least one first structure in the moving link state, wherein the structure is not movable in relation to the at least one first structure in the static link state, wherein the at least one structure lock mechanism is coupled with the at least one linking element, wherein the at least one structure lock mechanism transitions the at least one linking element to the static link state from the moving link state in the structure locked state, wherein the at least one structure lock mechanism transitions the at least one linking element to the moving link state from the static link state in the structure unlocked state.

8. The programmable surface object of claim 7, wherein the at least one linking element comprises at least one elastically deformable linking element, wherein the at least one elastically deformable linking element elastically deforms in the moving link state allowing the structure to move in relation to the at least one first structure, wherein the at least one elastically deformable linking element does not elastically deform in the static link state preventing the structure to move in relation to the at least one first structure.

9. The programmable surface object of claim 7, wherein the at least one linking element detachably connects the structure to the at least one first structure, wherein the at least one linking element comprises at least one fastener disposed on a distal end of the at least one linking element, wherein the at least one linking element extends away from the structure, wherein the at least one fastener is detachably fastenable to at least one first fastener of at least one first linking element comprised in the at least one first structure, wherein the at least one fastener fastens to the at least one first fastener for connecting the structure to the at least one first structure, wherein the at least one fastener detaches from the at least one first fastener for detaching the structure from the at least one first structure.

10. The programmable surface object of claim 9, wherein the at least one first structure is associated with at least one first programmable surface object, wherein the connecting of the structure with the at least one first structure connects the programmable surface object to the at least one first programmable surface object, wherein the disconnecting of the structure from the at least one first structure disconnects the programmable surface object to the at least one first programmable surface object.

11. The programmable surface object of claim 10, wherein the at least one linking element is comprised in one or more sides of the structure and the at least one first linking element is comprised in one or more first sides of the at least one first structure, wherein the structure comprises one or more overlapping structure portions extending laterally from the one or more sides of the structure over the at least one linking element, wherein the one or more overlapping structure portions are disposable on one or more first structure portions of the at least one first structure based on the connecting of the structure with the at least one first structure for covering the at least one linking element and the at least one first linking element, wherein disposing of the one or more overlapping structure portions over the one or more structure portions form a continuous surface on a top side of the programmable surface object and the at least one first programmable surface object.

12. The programmable surface object of claim 9, wherein the at least one fastener comprises at least one hook, wherein the at least one first fastener comprises at least one catch, wherein the at least one hook is removably latchable to the at least one catch, wherein the at least one hook latches to the at least one catch for connecting the structure to the at least one first structure, wherein the at least one hook removes from the at least one catch for detaching the structure from the at least one first structure.

13. The programmable surface object of claim 9, wherein the at least one fastener comprises at least one magnetic element, wherein the at least one first fastener comprises at least one first magnetic element, wherein the at least one magnetic element is magnetically detachably attachable to the at least one first magnetic element, wherein the at least one magnetic element magnetically attaches to the at least one first magnetic element for connecting the structure to the at least one first structure, wherein the at least one magnetic element magnetically detaches from the at least one first magnetic element for detaching the structure from the at least one first structure.

14. The programmable surface object of claim 1, wherein the structure comprises a panel, wherein the plurality of variable compressibility elements comprises at least one locking mechanism and at least one spring, wherein a base end of the at least one spring is disposable on at least one surface and a top end of the at least one spring is interfacable with the panel, wherein the at least one locking mechanism is configurable for transitioning between an unlocked state and a locked state, wherein the at least one spring is configurable for transitioning between an extended spring state and at least one compressed spring state corresponding to one of the plurality of energy stimuli receivable by the at least one spring through the panel, wherein the at least one locking mechanism is configured for unlockably locking the at least one spring based on the transitioning of the at least one locking mechanism between the locked state and the unlocked state, wherein the at least one locking mechanism unlocks the at least one spring in the unlocked state allowing the transitioning of the at least one spring between the extended spring state and the at least one compressed spring state for allowing the compressing of the structure, wherein the at least one locking mechanism locks the at least one spring in the locked state preventing the transitioning of the at least one spring between the extended spring state and the at least one compressed spring state for preventing the compressing of the structure.

15. The programmable surface object of claim 1, wherein the structure comprises a panel, wherein the plurality of variable compressibility elements comprises at least one rigid support and at least one spring, wherein a base end of the at least rigid support and the at least one spring are disposable on at least one surface and a top end of the at least one rigid support and the at least one spring are interfacable with the panel, wherein the at least one rigid support is configurable for transitioning between an extended state and at least one retracted state, wherein the at least one rigid support is configured for supporting the panel in the extended state preventing the compressing of the structure, wherein the at least one rigid support does not support the panel in the at least one retracted state allowing the compressing of the structure, wherein the at least one spring is configurable for transitioning between an extended spring state and at least one compressed spring state, wherein a support length of the at least one rigid support in the extended state is greater than a spring length of the at least one spring in the extended spring state and the support length of the at least one rigid support in the at least one retracted state is smaller than the spring length of the at least one spring in the at least one retracted state, wherein the at least one rigid support prevents interfacing of the at least one spring with the at least one programmable surface for preventing receiving of one of the plurality of energy stimuli by the at least one spring through the panel in the extended state, wherein the preventing of the receiving of one of the plurality of energy stimuli prevents the transitioning of the at least one spring to the at least one compressed spring state from the extended spring state, wherein preventing the transitioning prevents the compressing of the structure, wherein the at least one rigid support allows interfacing of the at least one spring with the panel for allowing the receiving of one of the plurality of energy stimuli by the at least one spring through the panel in the at least one retracted state, wherein the allowing of the receiving of one of the plurality of energy stimuli allows the transitioning of the at least one spring to the at least one compressed spring state from the extended spring state, wherein allowing the transitioning allows the compressing of the structure.

16. The programmable surface object of claim 1 further comprising:
at least one first sensor disposed on the structure, wherein the at least one first sensor is configured for generating at least one first sensor data based on at least one physical state of the structure;
a processing device communicatively coupled with the at least one first sensor, wherein the processing device is configured for:
analyzing the at least one first sensor data;
determining at least one first trigger condition for the allowing of the compressing of the structure to one of the plurality of compression levels based on the analyzing; and
generating at least one first compressing command based on the determining; and
at least one stimulus providing device communicatively coupled with the processing device, wherein the at least one stimulus providing device is coupled with the plurality of variable compressibility elements, wherein the at least one stimulus providing device is configured for providing one of the plurality of energy stimuli to the plurality of variable compressibility elements based on the at least one first compressing command, wherein the allowing of the compressing of the structure to one of the plurality of compression levels is based on the providing.

17. The programmable surface object of claim 1 further comprising:
at least one second sensor disposed on the structure, wherein the at least one second sensor is configured for generating at least one second sensor data based on at least one interaction between the structure and at least one object;
a processing device communicatively coupled with the at least one second sensor, wherein the processing device is configured for:
analyzing the at least one second sensor data;
determining at least one second trigger condition for the allowing of the compressing of the structure to one of the plurality of compression levels based on the analyzing; and
generating at least one second compressing command based on the determining; and
at least one stimulus providing device communicatively coupled with the processing device, wherein the at least one stimulus providing device is coupled with the plurality of variable compressibility elements, wherein the at least one stimulus providing device is configured for providing one of the plurality of energy stimuli to the plurality of variable compressibility elements based on the at least one second compressing command, wherein the allowing of the compressing of the structure to one of the plurality of compression levels is based on the providing.

18. The programmable surface object of claim 1 further comprising:
a communication device configured for receiving at least one third compressing command from at least one input device; and
at least one stimulus providing device communicatively coupled with the communication device, wherein the at least one stimulus providing device is coupled with the plurality of variable compressibility elements, wherein the at least one stimulus providing device is configured for providing one of the plurality of energy stimuli to the plurality of variable compressibility elements based on the at least one third compressing command, wherein the allowing of the compressing of the structure to one of the plurality of compression levels is based on the providing.

19. A programmable surface object comprising:
a structure; and
a plurality of variable compressibility elements configured for allowing compressing of the structure to one of a plurality of compression levels corresponding to one of a plurality of energy stimuli received by the plurality of variable compressibility elements, wherein the compressing of the structure allows deforming of the programmable surface object to one of a plurality of deforming degrees, wherein the structure comprises a panel, wherein the plurality of variable compressibility elements comprises at least one rigid support and at least one spring, wherein a base end of the at least rigid support and the at least one spring are disposable on at least one surface and a top end of the at least one rigid support and the at least one spring are interfacable with the panel, wherein the at least one rigid support is configurable for transitioning between an extended state and at least one retracted state, wherein the at least one rigid support is configured for supporting the panel in the extended state preventing the compressing of the structure, wherein the at least one rigid support does not support the panel in the at least one retracted state allowing the compressing of the structure, wherein the at least one spring is configurable for transitioning between an extended spring state and at least one compressed spring state, wherein a support length of the at least one rigid support in the extended state is greater than a spring length of the at least one spring in the extended spring state and the support length of the at least one rigid support in the at least one retracted state is smaller than the spring length of the at least one spring in the at least one retracted state, wherein the at least one rigid support prevents interfacing of the at least one spring with the at least one programmable surface for preventing receiving of one of the plurality of energy stimuli by the at least one spring through the panel in the extended state, wherein the preventing of the receiving of one of the plurality of energy stimuli prevents the transitioning of the at least one spring to the at least one compressed spring state from the extended spring state, wherein preventing the transitioning prevents the compressing of the structure, wherein the at least one rigid support allows interfacing of the at least one spring with the panel for allowing the receiving of one of the plurality of energy stimuli by the at least one spring through the panel in the at least one retracted state, wherein the allowing of the receiving of one of the plurality of energy stimuli allows the transitioning of the at least one spring to the at least one compressed spring state from the extended spring state, wherein allowing the transitioning allows the compressing of the structure.

20. A programmable surface object comprising:
a structure; and
a plurality of variable compressibility elements configured for allowing compressing of the structure to one of a plurality of compression levels corresponding to one of a plurality of energy stimuli received by the plurality of variable compressibility elements, wherein the compressing of the structure allows deforming of the programmable surface object to one of a plurality of deforming degrees, wherein the structure comprises at least one cavity, wherein the plurality of variable compressibility elements comprises at least one material and at least one inserting device, wherein the at least one inserting device is coupled with the at least one cavity, wherein the at least one inserting device is configured for removably inserting the at least one material in the at least one cavity in one of a plurality of amounts based on one of a plurality of electrical energy stimuli of the plurality of energy stimuli received by the at least one inserting device, wherein the allowing of the compressing of the structure to one of the plurality of compression levels is based on the removably inserting of the at least one material in the at least one cavity in one of the plurality of amounts.
